(19) United States
(12) Patent Application Publication
(10) Pub. No.: US 2013/0344400 A1
(43) Pub. Date: Dec. 26, 2013

(54) BIOCHEMICAL SYSTEMS FOR SULFUR AND CARBON SEQUESTRATION

(71) Applicants: Peter Girguis, Medford, MA (US); Clare E. Reimers, Philomath, OR (US)

(72) Inventors: Peter Girguis, Medford, MA (US); Clare E. Reimers, Philomath, OR (US)

(73) Assignees: OREGON STATE UNIVERSITY; PRESIDENT AND FELLOWS OF HARVARD COLLEGE

(21) Appl. No.: 13/991,785

(22) PCT Filed: Dec. 6, 2011
(86) PCT No.: PCT/US11/63395

§ 371 Date: Sep. 11, 2013

Related U.S. Application Data
(60) Provisional application No. 61/420,689, filed on Dec. 7, 2010.

(51) Int. Cl. H01M 8/16

(52) U.S. Cl. CPC H01M 8/16
USPC 429/401

(57) ABSTRACT

A fuel cell includes an anode including a current collector and microorganisms; a cathode; and a source of a sulfur-containing compound; wherein the fuel cell is poised for the microorganisms to selectively oxidize the sulfur-containing compound to elemental sulfur. Purification of a sulfur-contaminated fuel may be completed using such fuel cells. A method of carbon sequestration includes providing a fuel cell that includes a cathode including a conductor and oxygen; and an anode including a current collector and microorganisms; and introducing carbonic acid to the cathode to react with the oxygen to produce water and a carbonate or bicarbonate salt.

### CROSS-REFERENCE TO RELATED APPLICATIONS

This application claims the benefit of U.S. Provisional Patent Application No. 61/420,689, filed on Dec. 7, 2010, the entire disclosure of which is incorporated herein by reference for any and all purposes.

### GOVERNMENT INTERESTS

This invention was made with partial government support under HR0011-04-1-0023 awarded by the U.S. Department of Defense/DARPA. The Government has certain rights in this invention.

### FIELD

The technology generally relates to microbial fuel cells and other bioelectrochemical systems.

### BACKGROUND

An important challenge for energy production technologies is the negative impact from the release of green house gases such as carbon dioxide. As a result, techniques for carbon sequestration have been investigated.

In addition, contamination of high sulfur and other impurities in energy production and other areas continues to be a problem. Desulfurization is a major issue in the fossil fuels industry, including natural gas. The process of using biologically mediated reactions to remove sulfur from crude oil in particular has been attempted, e.g. the THIOPAQ™ process. THIOPAQ™ is a biotechnological process for removing H₂₅ from gaseous streams by absorption into a mild alkaline solution followed by the oxidation of the absorbed sulfide to elemental sulfur by microorganisms. The THIOPAQ™ trademark name is owned by Paques BV.

### SUMMARY

In one aspect, a fuel cell/bioelectrochemical cell is provided including an anode comprising a current collector and microorganisms; a cathode; and a source of a sulfur-containing compounds; wherein the fuel cell is poised for the microorganisms to selectively oxidize the sulfur-containing compound to elemental sulfur or sulfate or other oxidized sulfur compound. In some embodiments, the fuel cell is poised by electrical or electronic systems that are broadly described as potentiostats. In some embodiments, the fuel cell is poised by the activity of microbes on both the cathode and anode, and by an electrical or electronic monitoring system that varies resistance to maintain poise. In any of the above embodiments, the sulfur-containing compound includes H₂S and related species (HS⁻, S²⁻), thiosulfate, elemental sulfur, polysulfides, one or more mercaptans, or a mixture of any two or more thereof. In any of the above embodiments, where the sulfur-containing compound includes a mercaptan, the mercaptan is represented by the Formula RSR′, wherein R and R′ are independently H, alkyl, alkenyl, alkynyl, aryl, heteroaryl or heterocyclyl, with the proviso that R and R′ are not both H. In any of the above embodiments, the source of the sulfur-containing compound further includes a fuel and the microorganisms are configured to selectively oxidize the sulfur-containing compound without substantial oxidation of the fuel.

In any of the above embodiments, the anode and the cathode are separated by a proton exchange interface. In any of the above embodiments, the fuel cell also includes a load connected to the anode and the cathode.

In another aspect, a method is provided including contacting a feed gas stream with microorganisms in a fuel cell/bioelectrochemical cell to produce a purified gas stream; and collecting the purified gas stream; wherein: the fuel cell includes an anode comprising a current collector and the microorganisms; and a cathode comprising a current collector with of without microorganisms; the feed gas stream includes a fuel contaminated with a sulfur-containing compound; the purified gas stream includes the fuel with a lower concentration of the sulfur-containing compound than the feed gas stream; and the contacting is performed under conditions where the microorganisms selectively oxidize the sulfur-containing compound to elemental sulfur without, or minimally, oxidizing the fuel. In any of the above embodiments, the method also includes collecting the elemental sulfur from the anode.

In another aspect, a fuel cell is provided including an anode including a current collector and microorganisms; a cathode including oxygen and an aqueous electrolyte; and a source of carbon dioxide connected to the cathode; wherein the fuel cell is poised for the microorganisms oxidize a fuel at the anode. In any of the above embodiments, the cathode is configured to convert the carbon dioxide to a carbonate or bicarbonate salt.

In another aspect, a method is provided including providing a fuel cell including a cathode including a conductor and oxygen; and an anode including a current collector and microorganisms; and introducing carbonic acid to the cathode to react with the oxygen to produce water and a carbonate or bicarbonate salt.

### BRIEF DESCRIPTION OF THE DRAWINGS

FIG. 1 is a schematic of a method for sulfur sequestration in a microbial fuel cell, according to one embodiment.

FIG. 2 is schematic of a method for carbon sequestration in a microbial fuel cell, according to one embodiment.

### DETAILED DESCRIPTION

In the following detailed description, the illustrative embodiments described are not meant to be limiting. Other embodiments may be utilized, and other changes may be made, without departing from the spirit or scope of the subject matter presented here.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

In general, “substituted” refers to an alkyl or alkenyl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched chain alkyl groups having from 1 to 12 carbon atoms, and typically from 1 to 10 carbons or, in some embodiments, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2, 2-dimethylpropyl groups. Unless expressly indicated otherwise, alkyl groups may be substituted, or unsubstituted.

The terms “cyclic alkyl” or “cycloalkyl” refers to a saturated or partially saturated non-aromatic cyclic alkyl groups of from 3 to 14 carbon atoms and no ring heteroatoms and having a single ring or multiple rings including fused and bridged ring systems. Unless expressly indicated otherwise, cycloalkyl groups may be substituted or unsubstituted. Cycloalkyl or cyclic alkyl groups include mono-, bi- or tricyclic alkyl groups having from 3 to 14 carbon atoms in the ring(s), or, in some embodiments, 3 to 12, 3 to 10, 3 to 8, or 3 to 4, 5, 6 or 7 carbon atoms. Exemplary monocyclic cycloalkyl groups include, but not limited to, cyclopropyl, cyclobutyl, cyclopentyl, cyclohexyl, cycloheptyl, and cyclooctyl groups. Bi- and tricyclic ring systems include both bridged cycloalkyl groups and fused rings, such as, but not limited to, bicyclo[2.1.1]hexane, adamantyl, decalinyl, and the like.

Alkenyl groups include straight and branched chain and cycloalkyl groups as defined above, except that at least one double bond exists between two carbon atoms. Thus, alkenyl groups have from 2 to about 12 carbon atoms in some embodiments, from 2 to 10 carbon atoms in other embodiments, and from 2 to 8 carbon atoms in other embodiments. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Aryl group includes both substituted and unsubstituted aryl groups. Substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. In some embodiments, aralkyl groups contain 7 to 20 carbon atoms, 7 to 14 carbon atoms or 7 to 10 carbon atoms.

Heterocyclyl groups includes non-aromatic ring compounds containing 3 or more ring members, of which one or more is a heteroatom such as, but not limited to, N, O, and S. In some embodiments, heterocyclyl groups include 3 to 20 ring members, whereas other such groups have 3 to 6, 3 to 10, 3 to 12, or 3 to 15 ring members. Heterocyclyl groups encompass unsaturated, partially saturated and saturated ring systems, such as, for example, imidazolyl, imidazolinyl and imidazolidinyl groups. Unless expressly indicated otherwise, heterocyclyl groups may be substituted or unsubstituted. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl,azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthalenyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various substituents such as those listed above.

Heteroaryl groups are aromatic ring compounds containing 5 or more ring members, of which, one or more is a heteroatom such as, but not limited to, N, O, and S. Unless expressly indicated otherwise, heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridyl, pyridazinyl, pyrimidinyl, pyrazinyl, thiophenyl, benzothiophenyl, furanyl, benzofuranyl, indolyl, azaindolyl (pyrrolopyridyl), indazolyl, benzimidazolyl, imidazopyridyl (azabenzimidazolyl), pyrazolopyridyl, triazolopyridyl, benzotriazolyl, benzoxazolyl, benzothiazolyl, benzothiadiazolyl, imidazopyridyl, isoxazolopyridyl, thianaphthalenyl, purinyl, xanthinyl, adeninyl, guaninyl, quinolinyl, isoquinolinyl, tetrahydroquinolinyl, quinoxalinyl, and quinazolinyl groups.

A fuel cell is provided in which microorganisms (or microbes) can be used to sequester carbon and/or sulfur. Although this disclosure is generally directed to a fuel cell, it is contemplated that the disclosure may be used with other electrochemical devices. A fuel cell is a device that converts fuel to electrical energy without combustion of fuel. A fuel cell may include at least two electrodes (e.g. an anode and a cathode), an electrolyte in contact with the anode and an electrolyte in contact with the cathode, and an electrical circuit connecting the anode and the cathode from which power can be drawn, or to which power may be provided. A bioelectrochemical cell uses electricity to reduce or oxidize chemicals without combustion, through microbial catalytic activity. In some embodiments, the fuel cell may contain a plurality of anodes/or cathodes, e.g., in the same or in different environments, which may be operated in series and/or in parallel.

In the fuel cell, the anode and cathode may be separated by a separator. The term “separator” is used to mean a physical or other barrier that selectively allows certain gases or ions to pass through while impeding others species. In some embodiments, the separator allows more hydrogen gas and/or ions to pass as compared to other gases and other ions. In some embodiments, the separator may be directly attached to the electrode. As a non-limiting example the separator may be a film and the electrodes may be deposited on the film. In addition, the fuel cell may include one or more electrodes that are encased in an ion-permeable film. In some embodiments, the ion-permeable films allow solute exchange but prohibits or inhibits microbes from leaving the surface of the electrode. In other embodiments, the ion-permeable film prohibits microbes in the media from colonizing the surface of the electrode. The ion-permeable film may be made of various materials including but not limited to dialysis film, regenerated cellulose, tetrafluoroethylene (Teflon), or the like.

In some embodiments, the fuel cell operates according to the following process. An oxidant such as oxygen or air is provided to a cathode of a fuel cell where it is reduced e.g., to form water, while a fuel in the anode is oxidized, e.g., to produce CO₂, H⁺, and/or electrons. The electrons may be removed from the anode by a current collector, or other component of an electrical circuit, which results in an electrical current. The overall reaction may be energetically favorable. In other words, the reaction produces energy, driving electrons from the anode, through electrical circuitry, to the cathode. This energy may be captured for essentially any of a variety of purposes. For example, the energy may be immediately captured to drive an electrical device, or the energy may be stored in a battery or capacitor for later use.

The fuel cell may be either traditionally, or non-traditionally constructed, with the environment around the anode and cathode being compartmentalized, or being largely defined environments such as large open spaces, landfills, lakes, tundra, or permafrost. For example, in one embodiment, the fuel cell includes an anode compartment and/or a cathode compartment. Such compartments may be fabricated from thermally insulative and/or non-conductive materials. In some embodiments, the compartments are fabricated from a polymer, which may include, but is not limited to, polyvinyl chloride, polyethylene, polypropylene, or polyethylene terephthalate. In other embodiments, the thermally insulative and/or non-conductive materials are materials such as ceramics, glass, wood, and/or metals that may or may not be coated with thermal or electrical insulators, e.g. Teflon-coated aluminum, polymeric-coated steel, glass-lined stainless steel, etc. As discussed in detail below, in some embodiments of the disclosure, thermal insulators are useful for the management or retention of heat within the fuel cell, which may lead to higher microbial metabolism or efficiency, and/or higher power output.

In some embodiments, the fuel cell is non-traditionally constructed. By non-traditionally constructed it is meant that the fuel cell is not defined by a compartment, but rather an environment in which the anode(s) or cathode(s) are located. For example, the anode may be located in a landfill where microorganisms are found in a reduced-oxygen environment, while the cathode may be located in an oxygen-enriched environment. The anode may also be located in the sediment of a lake, river, or reservoir, or in the tundra or permafrost regions. The cathode may be located in the lake, air, or in a compartmentalized region.

In one aspect, the fuel cell may be a microbial fuel cell (MFC) which can be used to convert chemical energy to electrical energy by the catalytic reaction of microorganisms. In particular, the fuel cell may have a first compartment having an anode, and a second compartment having a cathode. The first and second compartments may be separated by a separator. It is understood that there may be microorganisms in the first and/or second compartment. The microorganisms may be present in a medium, media or mediator. The microorganisms may be attached to the surface of the anode or cathode electrodes or the separator.

In some embodiments, the cathode may be placed in a compartment with an abundance of oxygen (i.e. an aerobic environment), and/or in the presence of a soluble oxidant such as nitrate, sulfate, iron oxide, or manganese oxide, or in electrical continuity with oxygen or any appropriate oxidant, while the anode may be placed in a second compartment having an environment that is deficient in oxygen (i.e., an anaerobic environment), and/or other oxidants including, but not limited to, soluble oxidants such as nitrate, sulfate, iron oxide, manganese oxide, etc. In one embodiment, the anode contains a percentage of oxygen that is less than atmospheric oxygen, i.e., less than about 21% by total volume. For example, oxygen may be present in the second compartment at a percentage of less than about 18%, less than about 15%, or less than about 10% by volume. In another embodiment, the anode does not contain sufficient oxygen to completely oxidize any fuel present within the anode compartment. For example, the anode environment contains a less than stoichiometric amount of oxygen for complete combustion of the fuel, to form fully oxidized species such as CO₂, H₂O, NO₂, SO₂, and the like. For instance, the anode compartment may contain less than the stoichiometric amount of oxygen needed to oxidize the available fuel.

In some embodiments, the separator is a proton exchange membrane (PEM). In some embodiments, the PEM allows protons and/or gases to pass through, while substantially excluding other chemical compounds from passing through. One illustrative gas that may pass through the membrane is hydrogen gas.

In some embodiments, the PEM is an insulator, or it has a relatively high electrical resistance. In some embodiments, the PEM may be formed from a material having a resistivity of at least about 100 Ωm (ohm m). For example, the PEM may have a resistivity of at least about 105 Ωm, at least about 1010 Ωm, or at least about 1015 Ωm, etc. In other embodiments, the PEM has a resistivity from about 100 Ωm to about 200 Ωm. Accordingly, the PEM may allow gases (e.g., produced by microorganisms oxidizing a fuel) to pass through, while electrons are collected by the electrodes to produce electricity.

In some embodiments, the PEM preferentially allows hydrogen ion transport relative to non-hydrogen ions. It is contemplated that the PEM may allow some non-hydrogen ions and/or other molecules to pass through, but the PEM may exhibit a preference for passing hydrogen ion as compared to other ions or molecules. It is understood that the preference of the PEM may result in a higher concentration of hydrogen ion on the other side as compared to the concentration of the hydrogen ion on the first side.

The PEM may be a polymeric membrane composed of materials that include, but are not limited to, ionomeric polymers or polymeric electrolytes, according to some embodiments. For example, in one embodiment, the membrane comprises Nafion. Those of ordinary skill in the art will be familiar with proton exchange membranes, such as those used in proton exchange membrane fuel cells. However, in other embodiments, the proton exchange interface may be non-polymeric.

The electrodes of the fuel cell may be designed to have relatively large surface areas. For example, the electrodes may be porous or comprise wires or a mesh, or a plurality of wires or meshes. In some embodiments, multiple layers of such materials may be used. In some cases, the electrode may also be gas permeable, e.g., to avoid trapping gases such as H₂ or CO₂. In some embodiments, an electrode may include a terminal electron acceptor, and electrons collected by the electrode when a fuel is oxidized by microorganisms in the fuel cell may be collected as electricity. In some cases, the electrode may contain a conductive species, such as graphite, which may facilitate electron collection.

In one set of embodiments, the electrode is flexible and/or does not have a pre-defined shape. For example, an electrode may include cloth or a fabric, which may be conductive. Such electrodes may be useful, for instance, in embodiments where a currently existing system, such as a septic tank or a sewage treatment plant, is converted for use as a fuel cell. Such electrodes may also be useful, in certain cases, to increase the effective reactive surface area without increasing the weight or cost. Further, in some cases, such electrodes may be useful in increasing the amount of electrode surface area available for reaction within a compartment of a fuel cell. Examples of flexible materials suitable for use in flexible electrodes includes, but are not limited to, graphite cloth, carbon fiber cloth, carbon fiber impregnated cloth, graphite paper, and the like.

The electrode may be formed of and/or include a non-conductive material, and a conductive coating at least partially surrounding the non-conductive material. For instance, the conductive coating may be graphite, such as a graphite-containing paint or a graphite-containing spray, which may be painted or sprayed on, respectively. The non-conductive material may be a ceramic, or a non-conducting polymer, such as polyvinyl chloride or glass. In one embodiment, the non-conductive material is the housing of the compartment itself that contains the electrode. Thus, for example, an electrode of the device may be painted on, sprayed on, or otherwise applied to a wall of the compartment. The electrode may include a conductive material, optionally surrounded by a conductive coating. For instance, the electrode may include a metal, such as aluminum or lead.

The electrodes may be formed using conductive coatings or paints. For instance, a suspension of about 10% to about 60% graphite, or about 20% to about 60% graphite in a volatile solvent (e.g., methyl ethyl ketone) with an adhesive (e.g., a fluoroelastomer) may used as a graphite paint, and use to paint a non-conductive material such as a metal, a non-conductive polymer, or a ceramic. Graphite paints are readily available commercially, and in some cases, the paint may be supplemented with additional graphite to increase its density. In some cases, a wire may be added to the surface prior to coating, and connected to an electrical load, such as those described herein. In some cases, the wire can be potted with a high-temperature water resistant adhesive, e.g. marine epoxy, that may allow the point of continuity between the wire and the conductive electrode to remain dry, even if the assembly is immersed.

The electrodes may include porous materials. Such electrodes may have higher surface areas for electron transport, and/or such electrodes may provide suitable channels for mass and energy flow through the electrodes. For example, the transport channels may be used to avoid the trapping of gases such as H₂ or CO₂. The average pore size of the materials may range from about 100 μm to about 10 mm. In other embodiments, the average pore size is less than about 10 mm, and in other embodiments, it is less than about 1 mm. The average pore size may be determined by any method known to those of ordinary skill in the art. For example, density measurements, optical and/or electron microscopy images, or porosimetry may be used to determine the porosity of the material. Porosimetry is conducted by measuring the intrusion of a non-wetting liquid (often mercury) at high pressure into the material, and is usually taken as the number average size of the pores present in the material. Such techniques for determining porosity of a sample are known to those of ordinary skill in the art. For example, porosimetry measurements can be used to determine the average pore size based on the pressure needed to force liquid into the pores of the sample. A non-limiting example of a porous material is a laminate sheet of an inert material such as, but not limited to, carbon fiber, woven titanium, or a mesh or plurality of meshes. For instance, the spacing of one, or more than one of the meshes may range from about 100 micrometers to about 10 mm. In other embodiments, the mesh has a size that is less than about 10 mm, or in other embodiments, less than about 1 mm.

The electrode may include graphite, in some embodiments. Non-limiting examples of such electrodes include graphite cloth, carbon fiber cloth, graphite paper, a graphite-containing coating, a graphite-containing paint, or a graphite-containing powder. Graphite may be useful, for example, as a conductive non-metallic material; in some cases, metal electrodes may cause the release of metal ions, which may be toxic to the microorganisms at relatively high concentrations. The electrode may be formed from graphite (e.g., a graphite plate or a graphite rod), or formed from other materials to which graphite is added and/or upon which the graphite is adhered.

In some cases, the anode environment is anaerobic, meaning that the environment is deficient in oxygen gas (O₂) or other dissolved oxidants such as nitrate or sulfate. In such a case, electrons produced during oxidation of a fuel by the microorganisms are not passed to oxygen or other endogenous oxidants, as a terminal electron acceptor (e.g., to produce H₂O), but instead can be collected by the anode as electricity which is transmitted via a conductor to the cathode. In some cases, at least about 5% of the electrons accepted by the anode are produced by the microorganisms, and in some cases, at least about 10%, at least about 25%, at least about 50%, at least about 75%, or at least about 100% of the electrons accepted by the anode are produced by the microorganisms.

The fuel may be present within the anode compartment before the fuel cell is used to produce electricity (a “closed” fuel cell), or added during operation of the fuel cell to produce electricity (an “open” fuel cell).

Microorganisms in the anode environment metabolize fuel and transfer electrons produced during this process to the anode. Because of the difference in electrical potential between the anode environment and the cathode environment, the electrons move towards cathode. The microorganisms within the anode compartment thus are able to utilize the anode as a terminal electron acceptor, thereby producing electrical current. In some cases, the potential created between the anode and the cathode may range from about 0.01 V and about 5 V. In other embodiments, the potential between the anode and cathode is from about 0.1 V to about 4 V, from about 0.1 V to about 3 V, from about 0.1 V to about 2 V, from about 0.1 V to about 1 V, from about 0.2 V to about 0.7 V, or from about 0.2V to about 0.5 V.

The fuel cells described herein may produce relatively high power output. For example, the fuel cell is able to produce power of at least about 1 W/m² of electrode surface, in one embodiment. In another embodiment, the fuel cell is able to produce power of at least about 1.6 W/m² of electrode surface. In another embodiment, the fuel cell is able to produce power of at least about 2.7 W/m² of electrode surface. In another embodiment, the fuel cell is able to produce power of at least about 4.3 W/m² of electrode surface. In one embodiment, the fuel cell is able to produce power of about 1 W/m² to about 4.3 W/m² of electrode surface. In some embodiments, the fuel cell may be heated, for example, internally or externally of the compartment containing the microorganisms. However, in some cases, there may be no active heating of the fuel cell, i.e., the fuel cell is constructed and arranged to passively control its operating temperature. Instead, as the microorganisms may produce heat during oxidation of the fuel, such heat may be retained to heat the compartment containing the microorganisms. In yet other embodiments, a combination of active and passive heating may be used.

The microorganisms may be aerobic and/or anaerobic, and may include bacteria, fungi, archaea, protists, etc. In one embodiment, the microorganisms are methanotrophs, i.e., the microorganisms are able to metabolize methane, e.g., as a carbon source. Examples of methanotrophs include, but are not limited to, Methylomonas methanica, Methylococcus capsulatus, any of the alpha or gamma proteobacteria known to be responsible for aerobic methanotrophy or other microorganisms involved in methanotrophy. For example, other methanotrophs may include various species of bacteria, fungi, microeukaryotes, Crenarchaeota or Euryarchaeota, including but not limited to the known anaerobic methane oxidizing archaea allied to the group ANME-1, ANME-2, and ANME-3 archaea. Methanotrophs may also include assemblages of microbes that carry out this net activity, including the ANME archaea and their associated bacteria such as Desulfobulbus proprionicus, Desulfosarcinales, Desulfocapsa species, and other known sulfur-metabolizing microbes.

In other embodiments, the microorganisms are sulfur cycling organisms and communities such as Chromatium, Chlorobium, Beggiatoa, Thiothrix, Thiomicrospira, Thiobacillus, Acidithiobacillus, Desulfovibrio, Desulfuromonas, Desulfobulbus, Desulfocapsa, or any other bacteria, archaea, eukarya or other microorganisms that can convert sulfur-containing compounds to elemental sulfur (S⁰) or other oxidized sulfur species. Such sulfur converting organisms produce sulfur treating enzymes such as, but not limited to, methyl mercaptan oxidase, dissimilatory sulfite reductase, sulfide dehydrogenase, sulfite oxidase/reductase, thiosulfate sulfur transferase, and oxidases.

The microorganisms may be unicellular, although in some cases, the microorganisms may include multicellular lower organisms. The microorganisms are usually, but not always, of microscopic dimensions, i.e., being too small to be seen by the human eye.

The microorganisms used in the fuel cell may be a monoculture, or in some cases, a diverse culture or population of phylotypes. The term “phylotype,” as used herein, is used to describe an organism whose genetic sequence differs from known species by less than approximately 2% or less than approximately 1% of its base pairs. For example, the microorganisms contained within a fuel cell that are able to oxidize a fuel to produce electricity may comprise at least 10 phylotypes, at least 30 phylotypes, at least 100 phylotypes, at least 300 phylotypes, at least 1,000 phylotypes, etc. of various microorganisms, which may not all necessarily be fully characterized for operation of the fuel cell. The microorganisms may be naturally occurring, genetically engineered, and/or selected via natural selection processes. For example, in one embodiment, a population of microorganisms used as an inoculum in a fuel cell of the disclosure may be taken from another microbial fuel cell, which may also be a microbial fuel cell of the disclosure; repetition of this process may result in natural selection of a population of microorganisms having desirable characteristics, such as the ability to rapidly oxidize specific types of fuel.

The microorganism population within the fuel cell may not be well-defined or characterized. There may be a population of various microorganisms contained within the fuel cell that are able to oxidize a methane or other carbon-containing fuels to produce electricity, and the species of microorganisms forming such populations need not be explicitly identified or characterized. There may be at least 10 species, at least 30 species, at least 100 species, at least 300 species, at least 1,000 species, etc. of various microorganisms within the fuel cell that are able to, in whole or in part, directly oxidize methane or other carbon-containing fuels to produce electricity. For instance, in some cases, two or more species of microorganisms together define a reaction pathway where methane or other carbon-containing fuels is oxidized to produce electricity.

In some embodiments, the microorganisms are poised to selectively oxidize sulfur-containing species in a feedstock, to the exclusion of, or only minimal oxidation of, other materials that may in the feedstock. For example, the feedstock may be a fuel which is contaminated with sulfur-containing species. As is well understood in the art, sulfur-containing species can be extremely detrimental to catalyst systems in reformation catalysts, catalytic converters, or fluidized bed reactors, or detrimental to internal combustion engines, and the presence of sulfur in such fuels leads to environmentally harmful products that contribute to acid rain when the fuel is burned. Thus, where a feedstock that is a fuel is contaminated by sulfur species, the fuel cells of the present application may be poised in such a manner that the sulfur species is converted to elemental sulfur at the anode, where it can be collected, and the fuel may then be passed on to other systems that can effectively use the fuel. Thus, the fuel cells can be used to purify a sulfur-contaminated fuel feedstock such as a gas, liquid, or solid fuel.

The methods include contacting a feed gas stream with microorganisms in a fuel cell to produce a purified gas stream; and collecting the purified gas stream. In such embodiments, the fuel cell includes an anode and a cathode, the anode including a current collector and the microorganisms. The feed gas stream may include a fuel contaminated with a sulfur-containing compound, and the purified gas stream includes the fuel with a lower concentration of the sulfur-containing compound than the feed gas stream. In such embodiments, the contacting is performed under conditions where the microorganisms selectively oxidize the sulfur-containing compound to elemental sulfur without, or minimally, oxidizing the fuel. The methods may also include collecting the elemental sulfur from the anode.

In some embodiments, at least some of the microorganisms within the fuel cell are anaerobic. For example, the microorganisms do not require oxygen for growth, although the microorganisms, in some cases, can tolerate the presence of oxygen (aerotolerant), or even use oxygen for growth, when oxygen is present (facultative anaerobes). Those of ordinary skill in the art will be able to identify a microorganism as an aerobe or an anaerobe, e.g., by culturing the microorganism in the presence and in the absence of oxygen (or in a reduced concentration of ambient oxygen). Such anaerobic microorganisms are often found in lower regions of soil (where there is a reduced amount of oxygen present), and generally are able to oxidize or metabolize a fuel without using oxygen as a terminal electron acceptor. A terminal electron acceptor is generally a chemical species, such as oxygen (O₂), that is reduced upon acceptance of electrons to produce a species that is not further reduced by acceptance of electrons; for instance, O₂ may be reduced to form H₂O.

In one embodiment, a microorganism is able to transfer electrons to a non-oxygen (O₂) species that is able to act as a terminal electron acceptor. For instance, the terminal electron acceptor may be a metal such as, but not limited to, iron, cobalt, nickel, palladium, platinum, silver, gold, copper, or manganese; ammonia; a nitrate; a nitrite; sulfur; a sulfate; a selenate; or an arsenate. Note that the terminal electron acceptor may include bound oxygen in some cases (for example, as in a nitrate or a nitrite) but the terminal electron acceptor is not O₂. As discussed below, an electrode may function as a terminal electron acceptor, and the electrons collected by the electrode may be collected as electricity. In some cases, the electrode may contain an oxidizable and/or a conductive species, which may facilitate electron collection.

The fuel for the fuel cell may include alkanes, alkenes, alkynes, aryl compounds, heterocyclyl compound, heteroaryl compounds, or sulfur-containing compounds. The fuel may be delivered in any suitable form. For instance, the fuel may be delivered as a gas, a liquid, or a solid. The fuel may be either purified or with other components or contaminants which are present. For example, the fuel may contain oxygen, nitrogen, hydrogen, CO, CO₂, NO_{N}, SO_{N}, or the like. As a non-limiting example, oxygen may be present if at least some of the microorganisms are aerobic. As noted above, the fuel may be contaminated with a sulfur-containing compound, however, the sulfur-containing compound is also a fuel which the microorganisms may utilize in producing the electrons that are captured by the anode.

In some embodiments, the fuel is a C₁-C₁₀ alkane. For example, the fuel may be, but is not limited to, methane, ethane, propane, butane, pentane, hexane, or octane. The listing of these individual alkanes includes their normal regioisomer, as well as all of their branched regioisomers as well. In some embodiments, where the fuel is methane, the methane may be produced from materials such as chemical or industrial reactions, or biomass, i.e., matter derived from living biological organisms. “Biomass,” as used herein, may arise from plants or animals. For example, plants such as switchgrass, hemp, corn, poplar, willow, or sugarcane may be used as a fuel source in a fuel cell of the present disclosure. The entire plant, or a portion of a plant, may be used as the fuel source, depending on the type of plant. As another example, biomass may be derived from animals, for instance, animal waste or animal feces, including human sewage (which may be used raw, or after some treatment). Still other non-limiting examples of biomass include food scraps, lawn and garden clippings, dog feces, bird feces, composted livestock waste, untreated poultry waste, etc. The biomass need not be precisely defined. In some cases, the biomass does not necessarily exclude fossil fuels such as oil, petroleum, coal, etc., which are not derived from recently living biological organisms, nor does it exclude refined or processed materials such as kerosene or gasoline. For example, biomass used as fuel in various fuel cells of the present disclosure may be derived from a compost pile, a manure pile, a septic tank, a sewage treatment facility, etc., and/or from naturally organic-rich environments such as estuaries, peat bogs, methane bogs, riverbeds, plant litter, etc.

In other embodiments, the fuel is a sulfur-containing species, such as but not limited to H₂₅ and daughter species (HS⁻, S²⁻), thiosulfate, elemental sulfur, a mercaptan of formula RSR′, polysulfides, or a mixture of any two or more such materials. Where the sulfur-containing species is a mercaptan of formula RSR′, R and R′ are independently H, alkyl, alkenyl, alkynyl, aryl, heteroaryl or heterocyclyl, with the proviso that R and R′ are not both H. In some embodiments, R is alkyl, alkenyl, alkynyl, aryl, heteroaryl or heterocyclyl and R′ is H. In other embodiments, R is alkyl or aryl. In other embodiments, R is C₁-C₈ alkyl. In other embodiments, R is phenyl or a substituted phenyl. As used herein, polysulfide compounds include polymeric compounds that have one or more sulfur atoms in the monomeric unit. Such compounds include, but are not limited to hydrogen and organic polysulfides. Table 1 provides a listing of sulfur-containing compounds, their oxidized products, and enzymes which may be utilized for the conversion.

TABLE 1

| Reductant | Oxidant | Diagnostic Enzyme |
|---|---|---|
| Mercaptans | Elemental Sulfur (S⁰) | e.g. methyl mercaptan oxidase |
| Sulfide | Sulfite | Dissimilatory sulfite reductase |
| Sulfide | S⁰ | Sulfide dehydrogenase |
| Sulfide | Sulfate | Sulfite oxidase/reductase |
| Sulfite | Thiosulfate | Thiosulfate sulfur transferase |
| Thiosulfate | Sulfite | Thiosulfate sulfur transferase |
| Thiosulfate | S⁰ | Oxidases |
| Thiosulfate | Sulfate | Oxidases |
| Polysulfide | Sulfate | Oxidases |

In some embodiments, microorganism growth within a fuel cell of the present disclosure may be enhanced by the addition of suitable [symbol] growth agents, such as fertilizer or other nitrogen sources, to the fuel cell. The growth agent may be added to the fuel cell at any suitable time, for example, sequentially and/or simultaneously with the addition of fuel to the fuel cell. The growth agent may be any species able to increase metabolism of a fuel by the microorganisms during operation of the fuel cell, relative to their growth in the absence of the species, and the growth agent may include one, or a plurality, of compounds. The growth agent need not be precisely defined. For example, in some cases, the growth agent may be derived from biomass, for example, animal waste or animal manure (e.g., horse manure, poultry, etc).

In some embodiments, agricultural fertilizer is added to the fuel cell. The fertilizer may contain elements such as nitrogen, phosphorous, and/or potassium (in any suitable compound), which may promote microbial growth. Other examples of elements that may be contained within the fertilizer include, but are not limited to, calcium, sulfur, magnesium, boron, chlorine, manganese, iron, zinc, copper, molybdenum, or the like. In some embodiments, the fertilizer is a commercially available fertilizer. For example, the fertilizer used in the fuel cell may be plant fertilizer, which is often having a “grade” that describes the percentage amounts of nitrogen, phosphorous, and potassium that is present within the fertilizer. For instance, a fertilizer may have a grade of at least 3-3-2, i.e., comprising at least 3% nitrogen, at least 3% phosphorous, and at least 2% potassium. In one embodiment, the fertilizer comprises substantially equal parts of nitrogen, phosphorous, and potassium. However, the fertilizer is not required to have all three of nitrogen, phosphorous, and potassium.

In some embodiments, a nitrogen source, such as ammonia, a nitrate (e.g., sodium nitrate, potassium nitrate, etc.), or a nitrite (e.g., sodium nitrite, potassium nitrite, etc.) may be passed into the fuel cell as a growth agent, where the nitrogen source is any source of nitrogen that can be metabolized by microorganisms contained within the fuel cell. Nitrogen itself (i.e., N2) may be a nitrogen source, if the microorganisms are anaerobic and contain the appropriate pathways and enzymes (e.g., using nitrogenases) in sufficient quantities for the nitrogen to be useful as a growth agent. In some embodiments, as mentioned, a fertilizer may include a nitrogen source. In another embodiment, one or more free amino acids are passed into the fuel cell. Examples of amino acids that may be provided to the fuel cell include, but are not limited to, isoleucine, leucine, lysine, methionine, phenylalanine, threonine, tryptophan, and valine, arginine, cysteine, glycine, glutamine, or tyrosine. Such free amino acids may also be nitrogen sources.

In some embodiments, other materials may also be passed into the fuel cell, e.g. as growth agents, or to control conditions within the fuel cell, for instance, to create conditions conducive for microorganism oxidation of a fuel to occur. For example, electrically conductive substrates may be supplied, e.g., to enhance electrical conduction between the microorganisms and the electrodes, or species able to control pH, e.g., alkaline agents and/or acidification agents, may be supplied. Non-limiting examples of these include, but are not limited to, charcoal (e.g., activated charcoal) or lime.

Combinations of these and/or other materials are also contemplated. For example, in one embodiment, 1 part fuel having nearly equal parts nitrogen, phosphorous and potassium, 0.1 part of an alkaline agent such as lime, and 0.1 part of a electrically conductive substance such as activated charcoal may be used in a fuel cell.

In some cases, the introduction of growth agent or other materials, such as species able to control pH, may be regulated using a control system. For example, the temperature, pH, electrical output, etc. of a fuel cell of the present disclosure may be determined, using suitable sensors, and used to control the introduction of such materials into the fuel cell. For instance, the pH of the anode compartment may be measured, and if too low, an alkaline agent such as lime may be added to the anode compartment.

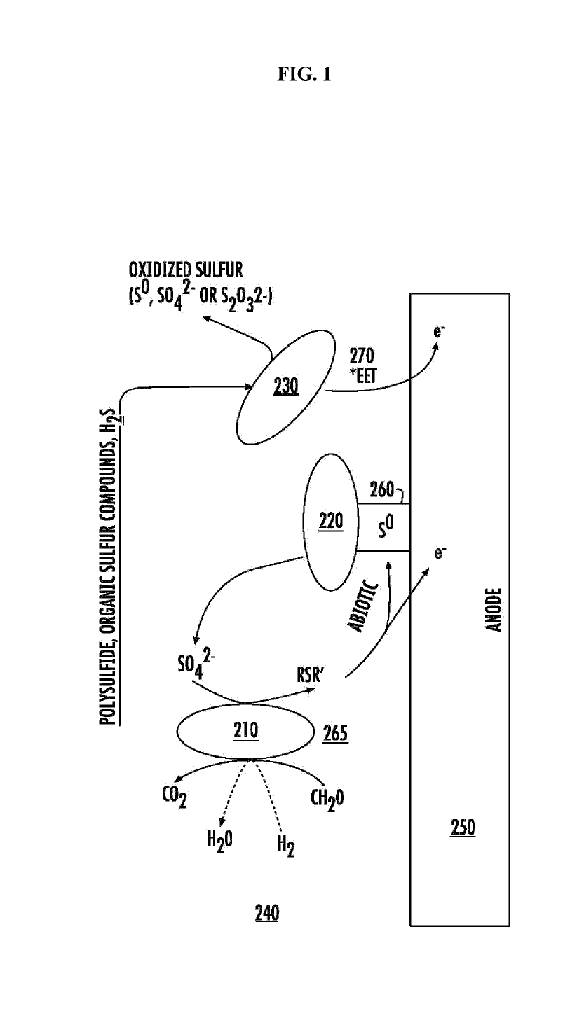

Turning now to the figures, a schematic view of one embodiment of a fuel cell for sulfur sequestration is shown in FIG. 1. In the figure, an anode environment 240 includes sulfur-transforming microorganisms 210, 220 and 230. The fuel cell also includes a cathode environment (not shown), and may optionally include a separator (not shown), and an electrical load (not shown). In general, the sulfur containing compound, RSR′, is contacted with the sulfur transforming microorganisms 210, at, or near, the anode surface. An electron produced during the oxidation of the sulfur-containing compound is then transferred to the anode 250, while elemental sulfur 260 is deposited on the anode 250. Sulfates (SO₄²), thiosulfates (S₂O₃²), or elemental sulfur (S⁰) are shown to be products of the process as illustrated at 270. As also shown in the figure, at 265, formaldehyde may be converted to carbon dioxide by the microorganisms.

During the oxidation process, electrons are generated and may be transferred to the anode 250. In some embodiments, the sulfur oxidation may also be an abiotic process or a chemical process. In some embodiments, the sulfur oxidation may include both biotic and abiotic processes.

In some embodiments, the sulfur-transforming microorganisms 230 may oxidize sulfur-containing compounds biotically including polysulfides, organic sulfur compounds and R—S—H including H₂₅ at point 270. It is understood that the sulfur-transforming microorganisms 230 may be located anywhere in the anode compartment 240 including attached to the anode electrode 250. In some embodiments, the microorganisms 230 can convert the sulfur-containing compounds into oxidized sulfur compounds including elemental sulfur, sulfate or sulfite, etc. In some embodiments, sulfur oxidation produces electrons by extracellular energy transfer (EET) as depicted in FIG. 1. It is contemplated that the electrons produced during sulfur oxidation may be used to produce electricity by the fuel cell.

In some embodiments a method of using the fuel cell to sequester sulfur-containing compounds is provided. In some embodiments, the fuel cell could be used, for instance, to reduce the total dissolved sulfur species in the system. In some embodiments, the fuel cell may be use to remove sulfur-containing compounds dissolved in the liquid and/or gaseous phases in the anode compartment 240. After oxidation, oxidized sulfur compounds are produced such as sulfates.

It is contemplated that high surface area electrodes could be deployed in gas streams and poise the system to select for the growth of microbes that are capable of sulfur-containing compounds to elemental sulfur. In some embodiments, the oxidized sulfur compound is elemental sulfur and may deposit in the anode compartment 240 including on the electrode 250. The sulfur can be easily removed via physical agitation, scrubbing or chemical dissolution, and may be sold for commercial purposes.

In some embodiments, the oxidized sulfur compounds may be collected by extraction in an aqueous phase or hydrocarbon phase. The oxidized sulfur compounds may be soluble in water but not in hydrocarbons. Other known methods of separation may be used to separate the oxidized sulfur compounds from the sulfur-containing compounds including formation of precipitates, ion exchange columns, acid- or base trapping (relying on differential pH to sequester compounds), adsorption, cryo-focusing, and distillation.

In another aspect, a method for carbon sequestration is provided using the fuel cell. In such a method, the fuel cells “trap” gaseous carbon dioxide as a bicarbonate or carbonate salt at the cathode. Bicarbonate salts, are typically soluble in water but form a crystalline white salt when dried. Carbonate are mostly insoluble, however some display pH-dependent solubility. Accordingly, carbonates may be readily separated and collected. The cathode compartment of the cell, when exposed to carbon dioxide, reduces the carbon dioxide to the bicarbonate or carbonate. The salts of the bicarbonate or carbonate may then be removed as a solid or solution, thereby sequestering the carbon from the CO₂. In this way, the carbon dioxide does not contribute to building up of green house gases. For example, the salts of carbonate and bicarbonate may include, but is not limited to, those of sodium, calcium, barium, magnesium, or potassium, and other available cations. Thus, in one embodiment, while the cell is sequestering sulfur species at the anode, carbon is being sequestered at the cathode.

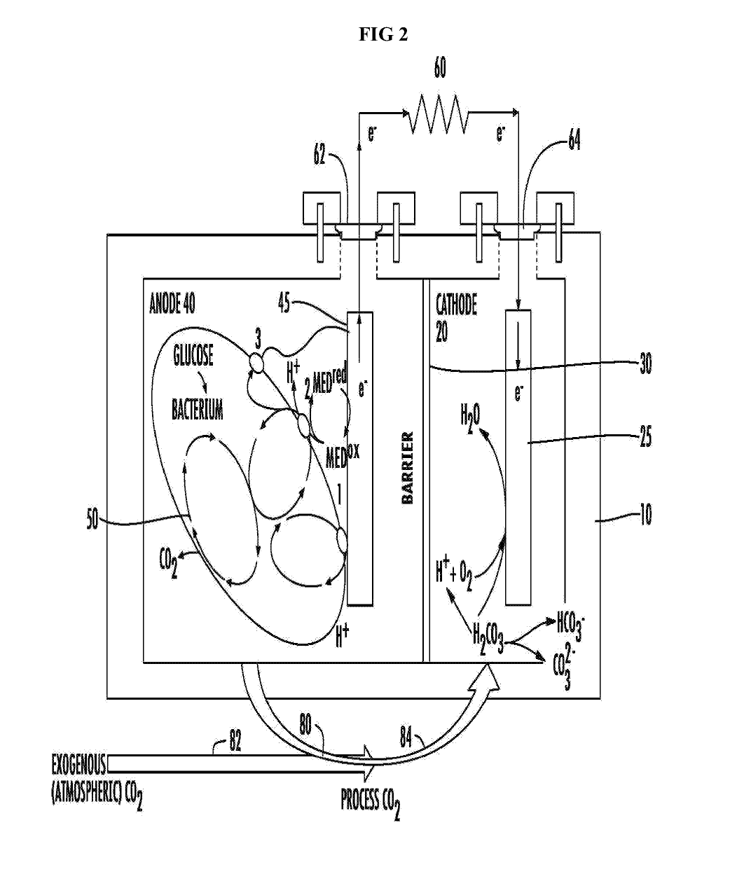

A schematic view of a fuel cell 10 for carbon sequestration is shown in FIG. 2. The fuel cell 10 includes a first environment 40 having an anode 45, and a second environment 20 having a cathode 25. The first and second environments 40, 20 may be discreet compartments, however, the first and second environments may be much more broadly defined to include compartments having a plurality of anodes and cathodes, or a they may be a much larger environment including a lake, a landfill, the permafrost, and the like. In some embodiments, where the first and second environments 40, 20 are discreet compartments, the compartment may be isolated by seals 62, 64. However, it is understood electrical connections can be maintained through the seals.

The anode 45 and the cathode 25 may be electrically connected via a load 60. For example, the load 60 may be a electrical device that consumes electricity. In some embodiments, the load 60 may be a light, a motor, a computer, and the like. As shown in FIG. 2, the potential difference between the anode 45 and cathode 25 results in net electron flow towards the load 60 to the cathode 25. The charge balance and continuity can be maintained by proton diffusion and/or transport from the anode compartment 40 to cathode compartment 20.

In some embodiments, the anode environment 40 may contain microorganisms 50. The microorganisms 50 are configured to oxidize a fuel, such an methane or other fuel as described above, to produce hydrogen (H₂) and/or electrons by the following, unbalanced equation:

CH₄→CO₂+H⁺+e

As shown in FIG. 2, the microorganisms 50 may process glucose to produce protons and carbon dioxide.

It is to be understood that the electrons produced by the microorganisms 50 may be transported to the anode 45 by various means. In some embodiments, the microorganism 50 may be attached to, or at least in close physical proximity to, the anode 45 and the transfer of electrons will be at the point of attachment, or of close proximity, 1. In some embodiments, the proton may be transported to the anode 45 via media molecules. The media molecules may interact with the electrons through various bonding or associations including ionic and covalent bonding. In some embodiments, the media molecules may accept the electrons to form a reduced media molecule (MED^{red}) at 2. When these molecules approach the anode 45, they may donate the electrons to the anode 45 to form an oxidized media particle (MED^{ox}). In some embodiments, there may be an electrical connection between the microorganism 50 and the anode 45 at 3 such that the electrons may be transferred.

According to some embodiments, a separator 30 (i.e. “barrier” in FIG. 1) is between the first and second environments 40, 20. The protons produced during oxidation of the fuel may be transported across the separator 30 from the first environment 40 to second environment 20. In some cases, barrier 30 is a PEM that allows protons or hydrogen to be transported across, but does not allow substantial transport of other dissolved compounds to occur, e.g., the interface may limit the diffusion of reduced or oxidized chemical compounds between the anode environment 40 and the cathode environment 20 that can have a deleterious effect on fuel cell performance. The PEM may prevent or at least inhibit oxygen gas from diffusing into the anode environment 40, while allowing hydrogen to move between the compartments, thereby allowing the anode environment to become anaerobic (deficient in oxygen) during operation of the fuel cell.

Hydrogen ion may enter the cathode environment 20 from the anode environment 40 through the separator 30. In the cathode environment 20, the hydrogen ion reacts with the oxygen to form water, thereby completing the electrical circuit with anode compartment 40. The overall reaction may be represented as:

O₂+H⁺+e- ->H₂O

The cathode environment 20 may be an aerobic environment, and in some cases, cathode 25 is open to the atmosphere and/or is in fluidic communication with the atmosphere through one or more conduits. In some embodiments, hydrogen may also be captured (e.g., via diffusion) into a gas collector overlying cathode environment 20.

The oxidation of the fuel by the microorganisms 50 produces acidic conditions in the anode environment 40. In addition, the anode environment 40 may contain sulfur-containing compounds which may contribute to the acidity. In the cathode environment 20, the protons are consumed, to produce a basic (i.e. alkaline environment). In some embodiments, the alkaline components in the cathode environment are then reacted with carbonic acid in an overall carbon sequestration process. In other words, carbon dioxide may be dissolved in the aqueous cathode environment, thus producing carbonic acid, which then may react with the alkaline species in solution to produce bicarbonate and/or carbonate salt species, in effect sequestering the carbon of the carbon dioxide.

In some embodiments, carbon dioxide 80 produced by microorganisms 50 in the anode environment 40 may be diverted and added to the cathode compartment 20 through stream 84. In some embodiments, carbon dioxide from exogenous sources 82 are added to the cathode environment 20. Such other exogenous sources include atmospheric carbon dioxide under ambient conditions, or compress carbon dioxide.

In some embodiments, the bicarbonate and/or carbonate salt species formed in the cathode environment 20 is a carbonate or a bicarbonate such as calcium carbonate, calcium bicarbonate, sodium carbonate, sodium bicarbonate, potassium carbonate, potassium bicarbonate, ammonium carbonate, or ammonium bicarbonate. In some embodiments, the formation of the salt may be dependant on the pH. In some embodiments, formation of bicarbonates are favored at higher pHs. Thus, the pH in the cathode environment 20 may be controlled to produce a particular bicarbonate or carbonate species.

The present technology, thus generally described, will be understood more readily by reference to the following examples, which are provided by way of illustration and are not intended to be limiting.

### EXAMPLES

Illustration of Sulfur Sequestration. Sulfur sequestration was demonstrated in hydrocarbon-rich and hydrocarbon-deleted laboratory and field experiments. In the laboratory, microbial fuel cells were constructed with graphite electrodes, titanium wire, and a custom potentiostat that poised the potential of the anode to that most similar to iron and manganese oxides typically found in nature (goethite, hematite, magnetite and birnessite). The systems were operated with a number of different cultured microbes including Arcobacter nitrofigilis among other Arcobacter spp. In addition, the systems were run with mixed microbial communities. Seawater and various artificial media were pumped into a flow-through reactor, which was packed with seafloor sediments, an inert artificial bead substrate, or a mixture of both. The seawater, or media, was replete with either hydrogen sulfide or bisulfide (which is the same compound, but a different species as a function of pH), thiosulfate, or elemental sulfur.

The cells were run for 180 consecutive days, and revealed a consistent pattern of both hydrocarbon oxidation and sulfur oxidation. Notably, the rates of hydrocarbon or sulfur oxidation were markedly different, and the system could be poised to favor the oxidation of one over the other by altering the electrical potential of the working electrode (with the microbes). For carbon sequestration, namely the oxidation of methane or other alkanes, the system was run with the electrode poised to provide an electron acceptor for the microbes but sufficiently electronegative to minimize sulfide oxidation. For sulfur sequestration, the system was run more electropositive. The electrodes, whether working with pure or mixed cultures, showed signs of elemental sulfur deposition, which, without being bound by theory is believed to be mitigated by the activity of sulfur disproportionating microbes that remove elemental sulfur from the electrode. Molecular microbial analyses of these systems revealed that the electrodes selected for the growth of a diversity of known sulfur-oxidizing microbes when the system is appropriately poised. All the epsilon proteobacteria tested, as well as other bacteria, were shown to exhibit electroactivity on the electrode, and oxidize a variety of sulfur-containing species. Notably, efficiencies of oxidation of sulfur-containing compounds were in excess of 90%, with a concomitant 2 to 10% coindicent oxidation of hydrocarbons. In hydrocarbon-free systems, efficiencies upwards of 95% were achieved by poising the electrode at a highly electropositive state. Notably, with respect to the presence of hydrocarbons, sulfide oxidation was most pronounced in the presence of methane, ethane, propane then butane respectively. Also, the accumulation of elemental sulfur and sulfate in the reactor validate the stoichiometric efficiencies described above.

Carbon sequestration at the cathode was tested by bubbling air through the cathode chamber and monitoring the change in total dissolved and insoluble inorganic carbon. Using the same setup, the cathode chamber was sparged with air at a constant rate, as well as with an enriched CO₂, low O₂ gas stream. Electron equivalents from the cathode and increased abundance of hydrogen ions in the cathode chamber resulted in the reduction of the CO₂ to bicarbonate (HCO₃⁻) or carbonate (CO₃²⁻) salts. This system sequestered 12% of the carbon stream (with low oxygen) and 4% of the carbon stream (from air) at maximal performance.

To test the efficacy of sulfur sequestration in naturally occurring ecosystems, a microbial fuel cell was deployed in the sulfur-rich hydrocarbon seeps in Monterey Canyon, at a depth of 1,000 meters under water. Benthic microbial fuel cells (BMFCs) with graphite anodes having geometric surface areas of 0.184 m² and carbon-brush cathodes demonstrated a maximal sustained (24 hr) power density of 34 mW/m² equating to 1100 mW per square meter of seafloor. Localized reductions in hydrogen sulfide were evident from the oxidized state of the sediment surrounding the electrodes and from subsequent geochemical characterizations. The molecular phylogenetic analyses of microbial biofilms that formed on the anode surface revealed microbial community composition along the anode as a function of sediment depth. Within the 20-29 cm sediment horizon, the anodic biofilm was dominated by microorganisms phylogenetically allied to Desulfuromonas acetoxidans, a sulfur-oxidizer. The MIDDLE and BOTTOM sediment horizons enriched for other, more diverse, communities on the anodic surface, with SSU rRNA genes from Geobacter-like phylotypes being scarce despite our having sequenced in excess of 500 SSU rRNA gene fragments Phylotypes from both the ∂- and ε-proteobacteria, including phylotypes allied to Desulfocapsa, were nearly equally represented in the clone libraries (FIG. 8).

Desulfocapsa are sulfate-reducing bacteria known to derive energy for growth from the disproportionation of S⁰. The dominant ε-proteobacteria recovered from the MIDDLE horizon have been shown to reduce a variety of inorganic compounds including nitrate, nitrite, polysulfide or dimethyl sulfoxide (DMSO) with formate as the electron donor. The BOTTOM horizon was also dominated by phylotypes allied to ε-proteobacteria. Abiotic “chemical fuel cells” illustrate that reduced substrates such as hydrogen sulfide will certainly diffuse to a BMFC anode, adsorb, transfer electrons and can slowly deposit elemental sulfur, according to equation 1.

HS⁻═S+H⁺+2e⁻ (1)

The process of equation 1 generates a potential of about −65 mV versus the standard hydrogen electrode. By decreasing the pH at the anode, that is expected to that the anodic oxidation will shift in favor of the reaction of sulfide to produce elemental sulfur, S⁰, rather than as a polysulfide, thiosulfate or sulfate. The presence of high concentrations of S⁰ especially within pores connected to the graphite surface is consistent with a S⁰ film. In the seep experiment, the BMFC was nearly always in a constant discharge state. Without periods of rest, anode deactivation by chemisorbed sulfur and other species appears irreversible, though previous studies have shown that relaxation of interfacial potential and chemical concentration gradients result in the precipitation of S⁰. It was observed that there was deposition of elemental sulfur on the anode of the microbial fuel cell at a striking rate, approximately two orders of magnitude faster than via an abiotic process alone. Such a result indicates that the sulfur-transforming microorganisms are active in sulfur oxidation.

### EQUIVALENTS

The use of the terms “a” and “an” and “the” and similar referents in the context of describing the elements (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally the phrase “consisting essentially of” will be understood to include those elements specifically recited and those additional elements that do not materially affect the basic and novel characteristics of the claimed invention. The phrase “consisting of” excludes any element not specifically specified.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-24. (canceled)

25. A method comprising:
contacting a feed gas stream with microorganisms in a bio-electrical system to produce a purified gas stream; and
collecting the purified gas stream;
wherein:
the bio-electrical system comprises:
an anode comprising a current collector and the microorganisms; and
a cathode;
the feed gas stream comprises a fuel contaminated with a sulfur-containing compound;
the purified gas stream comprises the fuel with a lower concentration of the sulfur-containing compound than the feed gas stream; and
the contacting is performed under conditions where the microorganisms selectively oxidize the sulfur-containing compound to elemental sulfur without, or minimally, oxidizing the fuel.

26. The method of claim 25 further comprising collecting the elemental sulfur from the anode.

27-32. (canceled)

33. A method comprising:
providing a bio-electrical system comprising:
a cathode comprising a conductor and oxygen; and
an anode comprising a current collector and microorganisms; and
introducing carbon dioxide to the cathode to react with the oxygen to produce water and a carbonate or bicarbonate salt.

34. The method of claim 33, wherein the carbonic acid is produced by the microorganisms, the carbon acid is formed by dissolving an exogenous source of carbon dioxide in water, or a combination thereof.

35. The method of claim 33, wherein the exogenous source of carbon dioxide is compressed carbon dioxide, compressed air, or a mixture thereof.

36. The method of claim 33, wherein the carbonate or bicarbonate salt is a salt of sodium, calcium, magnesium, manganese, iron, cobalt, aluminum, zinc, copper, lithium, hydrogen, cesium, strontium, barium, or potassium.

37. The method of claim 25, wherein the microorganisms comprise sulfur-oxidizing bacteria, archaea, or eukarya.

38. The method of claim 25, wherein the microorganisms comprise Arcobacter, Chromatium, Chlorobium, Beggiatoa, Thiothrix, Thiobacillus, Acidithiobacillus, Thiomicrospira, Desulfuromonas, or a mixture of any two or more thereof.

39. The method of claim 25, wherein at least some of the microorganisms are aerobic.

40. The method of claim 25, wherein at least some of the microorganisms are anaerobic.

41. The method of claim 25, wherein the sulfur-containing compound comprises H₂S, HS⁻, S²⁻, thiosulfate, elemental sulfur, polysulfide, one or more mercaptans, or a mixture of any two or more thereof.

42. The method of claim 25, wherein the sulfur-containing compound comprises H₂S, HS⁻, or S²⁻.

43. The method of claim 25, wherein the sulfur-containing compound comprises a mercaptan represented by the Formula RSR′, wherein R and R′ are independently H, alkyl, alkenyl, alkynyl, aryl, heteroaryl or heterocyclyl, with the proviso that R and R′ are not both H.

44. The method of claim 43, wherein R is alkyl, alkenyl, alkynyl, aryl, heteroaryl or heterocyclyl and R′ is H.

45. The method of claim 43, wherein R is alkyl or aryl.

46. The method of claim 43, wherein R is C₁-C₈ alkyl.

47. The method of claim 43, wherein R is phenyl or a substituted phenyl.

48. The method of claim 25, wherein the fuel is a C₁-C₁₀ alkane.

49. The method of claim 25, wherein the fuel is methane, ethane, propane, butane, pentane, pentane, hexane, heptane, or octane.
